(19) United States
(12) Patent Application Publication
(10) Pub. No.: US 2025/0378323 A1
(43) Pub. Date: Dec. 11, 2025

(54) SYSTEMS AND METHODS FOR ALIGNMENT OF NEURAL NETWORK BASED MODELS

(71) Applicant: Salesforce, Inc., San Francisco, CA (US)

(72) Inventors: Bo Pang, Los Angeles, CA (US); Yingbo Zhou, Palo Alto, CA (US); Caiming Xiong, Menlo Park, CA (US)

(21) Appl. No.: 18/738,870

(22) Filed: Jun. 10, 2024

(51) Int. Cl. G06N 3/08

(52) U.S. Cl. CPC G06N 3/08

(57) ABSTRACT

Embodiments described herein provide A method of fine-tuning a neural network based model. In some embodiments, a system receives, via a data interface, a training dataset including a plurality of input samples. The system generates, via a pre-trained neural network based model, a first response based on a first input sample of the plurality of input samples, and a second response based on the first input sample. The system generates, via a trained reward model, a first reward score based on the first input sample and the first response, and a second reward score based on the first input sample and the second response. The system computes a loss function based on the first prompt, the first response, the second response, the first reward score, and the second reward score. The system updates parameters of the neural network based model based on the loss function.

### TECHNICAL FIELD

The embodiments relate generally to machine learning systems for training neural network based models, and more specifically to systems and methods for alignment of neural network based models.

### BACKGROUND

Machine learning systems have been widely used in training neural network based models, for example large language models (LLMs). After a pre-training stage, LLMs are generally fine-tuned to align with human preferences. Existing methods for LLM fine-tuning includes reinforcement learning with human feedback (RLHF) methods. For example, in AI-simulated chess game, at each time step t, a neural network such as an LLM may generate and execute a next-step action, and a human-evaluated reward may be received for the LLM to learn how to improve to generate a human-preferred action. However, these methods are slow and relatively expensive, both because of the need for large amount of manual labor in annotating and computational resources. Therefore, there is a need for improved methods for alignment of neural network based models.

### BRIEF DESCRIPTION OF THE DRAWINGS

FIG. 1 is a simplified diagram illustrating a model training framework according to some embodiments.

FIG. 2A is a simplified diagram illustrating a computing device implementing the model training framework described in FIG. 1, according to some embodiments.

FIG. 2B is a simplified diagram illustrating a neural network structure, according to some embodiments.

FIG. 3 is a simplified block diagram of a networked system suitable for implementing the model training framework described in FIGS. 1-2B and other embodiments described herein.

FIG. 4 is an example logic flow diagram illustrating a method of fine-tuning a neural network based model based on the framework shown in FIGS. 1-3, according to some embodiments.

FIG. 5A provides an example pseudo-code segment illustrating an example algorithm for a method of fine-tuning a neural network based model based on the framework shown in FIGS. 1-4.

FIG. 5B provides an example logic flow diagram illustrating a method of fine-tuning a neural network based model according to the algorithm in FIG. 5A, according to some embodiments described herein.

FIGS. 6-11 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

### Overview

Machine learning systems have been widely used in training neural network based models, for example large language models (LLMs). LLMs trained on very large unsupervised datasets acquire a wide range of capacities and skillsets, completing tasks zero-shot or few-shot. However, a large unsupervised corpus contains text with various goals and values, which are not necessarily aligned with human preferences. After a pre-training stage, LLMs are generally fine-tuned to align with human preferences. Existing methods for LLM fine-tuning includes reinforcement learning with human feedback (RLHF) methods. For example, in AI-simulated chess game, at each time step t, a neural network such as an LLM may generate and execute a next-step action, and a human-evaluated reward may be received for the LLM to learn how to improve to generate a human-preferred action.

The reliance on complicated online RL methods such as RLHF is because the reward maximization (with some conservative constraint) in preference learning amounts to minimizing a reverse Kullback-Leibler (KL) divergence [symbol] _{KL} (πθ∥π*), where π* is the target response distribution or policy that aligns with human preference, and πθ is a parameteric policy (e.g., LLM) that is aimed to learn. Optimizing the reverse KL is not straightforward since sampling from πθ is not differentiable, and so existing methods have resorted to online RL methods to optimize this objective. However, these methods are slow and relatively expensive, both because of the need for large amount of manual labor in annotating and computational resources.

In view of the need for improved methods for alignment of neural network based models, embodiments described herein provide a generation framework that fine-tunes a generative neural network based model by generating multiple candidate responses relating to an input prompt, and then evaluating reward scores for the multiple candidate responses. Specifically, a neural network such as an LLM may generate multiple (e.g., 2, 3, 4, etc.) candidate responses to an input prompt sampled from a training dataset of input prompts. A preference probability may then be computed based on reward scores assigned to each of the candidate response by a reward model. The neural network may then be trained by a loss function computed based on differences in both directions between the multiple candidate responses weighted by the preference probability. In this way, the generation framework improves over the RLHF method by training an LLM using a reward-based learning method without direct human feedback.

Embodiments herein may be referred to as Alignment with Residual Energy-Based Model (ARM). Methods described herein align policy by minimizing a forward Kullback-Leibler (KL) divergence from a target policy (in the form of a residual energy-based model) to a parameteric policy (LLM), instead of a reverse KL as in RLHF methods. With samples from the energy-based target policy, methods can leverage the power of direct preference optimization (DPO) or other offline methods to learn an aligned policy efficiently.

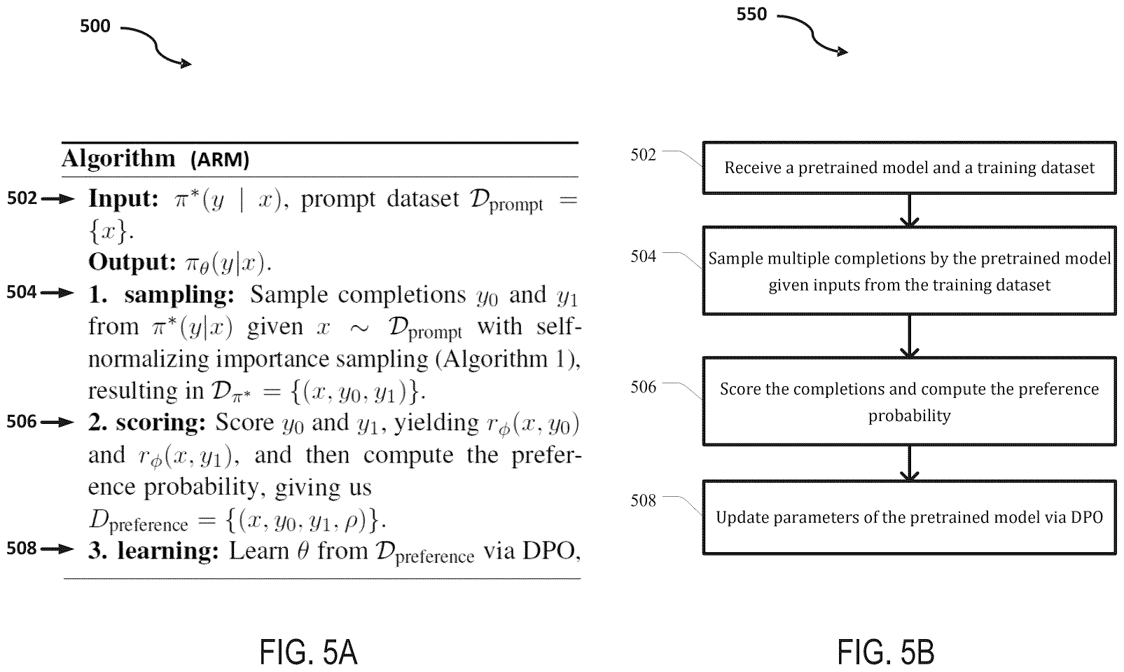

ARM may be implementable and applicable in various data settings. Experiments described in FIGS. 6-11 demonstrate its strong performance across multiple datasets, compared to strong baselines like proximal policy optimization (PPO) and DPO.

In some embodiments, a neural network based model (e.g., LLM) is fine-tuned by optimizing the forward KL, [symbol] KL (π*∥πθ). The target distribution π* is a residual energy-based model with a reference distribution, usually the supervised fine-tuning (SFT) distribution, as the base model and the surrogate reward function as the negative residual energy term. A system can sample from π* given a learned reference distribution and reward function, denoted as [symbol] π*. πθ may be learned from [symbol] π* with maximum likelihood estimation (MLE), or with any other offline method such as DPO. Examples provided herein focus on DP, although other methods are within the scope of embodiments.

Embodiments described herein provide a number of benefits to systems such as an intelligent chat agent server that employs LLMs. For example, embodiments described herein yield substantial improvements over SFT policies and outperform competitive baselines such as PPO and DPO. In addition to standard benchmarks, embodiments described herein show improvements when non-pairwise preference data are available and in low-resource settings. These experiments (e.g., experiments described in FIGS. 6-11) highlight the applicability of the methods to diverse settings due to their simplicity and flexibility. Therefore, with improved performance on training models, neural network technology in alignment of neural network based models is improved.

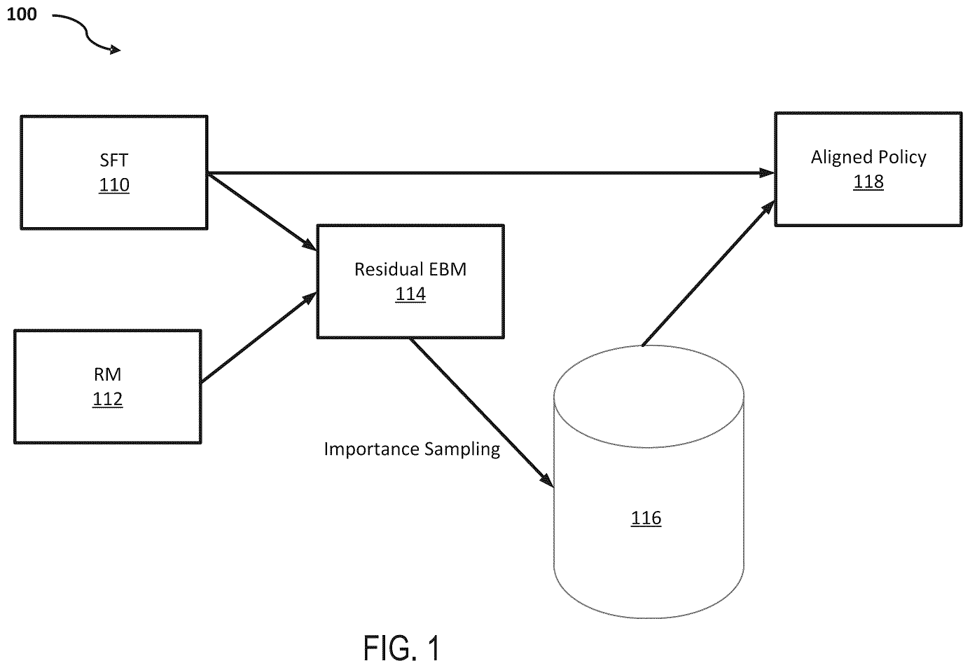

FIG. 1 is a simplified diagram illustrating a model training framework 100 according to some embodiments. The framework 100 may begin with a supervised fine-tuning of a LLM to provide supervised fine-tuned (SFT) model 110. The supervised fine-tuning stage may be performed using training data of known good pairs of inputs and outputs. A reward model (RM) 112 may be combined with SFT model 110 to provide a residual error based model (EBM) 114. The resulting EBM 114 may be used to generate sample pairs of training data 116 with self-normalized importance sampling. Importance sampling. As described further herein, importance sampling may be performed by using a training set of inputs, and for each input generating multiple candidate outputs whose relative importance is determined by RM 112. The resulting training data 116 may include, for example, the input data, and two output candidates, and an indication of the relative importance (e.g., quality) of each of the two output candidates. Training data 116 may be used to fine-tune SFT 110 to create aligned policy 118 (i.e., a fine-tuned LLM). This stage of training may be performed via DPO or other methods as described herein.

In some embodiments, the supervised fine tuning (SFT) stage fine-tunes the model on instructions and human-written completions. Given a dataset, [symbol] _{sft} ={(x, [symbol] )} where x is an instruction or a prompt and [symbol] is a human-written completion, SFT may be represented as

$${π}_{sft} = {max}_{π} {𝔼}_{( x , y ) ∼ {𝒟}_{sft}} [ log π ( y \vert x ) ] \qquad ( 1 )$$

To align model behavior with human value, RLHF may be applied after learning the SFT policy. This framework assumes there is a latent reward model r: x× [symbol] → [symbol] , such as Bradley-Terry model or more general Plackett-Luce model, that reflects human preference. Assuming access to {(x, [symbol] ₀, [symbol] ₁)} where [symbol] ₀, [symbol] ₁˜ π_{sft}(( [symbol] |x)), the Bradley-Terry model assumes human preference is captured by the following distribution:

$$p ( {y}_{1} ≻ {y}_{0} \vert x ) = \frac{exp ( r ( x , {y}_{1} ) )}{exp ( r ( x , {y}_{1} ) ) + exp ( r ( x , {y}_{0} ) )} \qquad ( 2 )$$

Defining z ˜ Bernoulli (p(y₁ [symbol] y₀ |x)), then one can generate a preference dataset, [symbol] _{pref}={(x, y₀, y₁, z)}. Given a parameteric form of reward model, r_{ϕ}(x,y), it can be learned with the negative log-likelihood loss:

$$ℒ ( ϕ ) = - {𝔼}_{( x , {y}_{0} , {y}_{1} , z )} ∼ {𝒟}_{{pref}^{}} [ z log σ ( {r}_{ϕ} ( x , {y}_{1} ) - {r}_{ϕ} ( x , {y}_{0} ) ) + ( 1 - z ) ( 1 - log σ ( {r}_{ϕ} ( x , {y}_{1} ) - {r}_{ϕ} ( x , {y}_{0} ) ) ) ] \qquad ( 3 )$$

Given π_{sft}((y|x) and r_{ϕ}(x, y), a policy πθ(y|x) may be learned with feedback from the reward model. The objective may be formulated as reward maximization with KL-constraint:

$${max}_{{π}_{θ}} {𝔼}_{( x ∼ 𝒟 , y ∼ {π}_{θ} ) ( y \vert x )} [ {r}_{ϕ} ( x , y ) ] - β {𝔻}_{KL} [ {π}_{θ} ( y \vert x ) \vert \vert {π}_{ref} ( y \vert x ) ] \qquad ( 4 )$$

where π_{ref} is often set to be π_{sft}. This objective may be optimized with online reinforcement learning (RL) methods such as PPO as described in Schulman et al., Proximal Policy Optimization Algorithms, arXiv:1707.06347, 2017; or DPO as described in Rafailov et al., Direct Preference Optimization: Your Language Model is Secretly a Reward Model, Thirty-Seventh Conference on Neural Information Processing Systems, 2023. In DPO, direct reward modeling is bypassed via a change of variables to define the preference loss as a function of the policy directly. Therefore, the policy can be trained with the preference loss directly. In particular, the DPO objective is as follows,

$${ℒ}_{DPO} ( {π}_{θ} ; {π}_{ref} ) = - {𝔼}_{( x , {y}_{w} , {y}_{1} )} ∼ 𝒟 [ log σ ( βlog \frac{{π}_{θ} ( {y}_{w} \vert x )}{{π}_{ref} ( {y}_{w} \vert x )} - β log \frac{{π}_{θ} ( {y}_{1} \vert x )}{{π}_{ref} ( {y}_{1} \vert x )} ) ] \qquad ( 5 )$$

where y_{w} is the preferred response and yₗ is the lesser preferred response given the prompt x.

The KL-constrained reward maximization objective defined in Equation (4) is equivalent to minimizing a reverse KL divergence, [symbol] _{KL} (πθ(y|x)∥π*(y|x)) where πθ(y|x) is the parametric policy being aligned with human value and

$$π * ( y \vert x ) ) = \frac{1}{Z ( x )} {π}_{sft} ( y \vert x ) exp ( \frac{1}{β} {r}_{∅} ( x , y ) ) .$$

One may learn πθ by minimizing [symbol] _{KL} (πθ∥π*). However, this approach faces two challenges. First, optimizing a reverse KL leads to mode collapsing. Second, it cannot be optimized end-to-end due to the non-differentiability of sampling from πθ (which has a discrete output space), and this is why alternate methods resort to RL-based methods such as PPO. While they produce language models with impressive capacities, these methods are considerably complicated to implement, tricky to tune, and computationally expensive to train (e.g., four LLMs need to be fit in GPU memory in PPO training).

Rather, πθ may be learned with the forward KL, [symbol] _{KL} (π*(y|x)∥πθ(y|x)). Following this principle, we embodiments herein provide a simple, efficient, flexible, and highly-performant method, and recast several heuristic-driven methods in a probabilistic framework. The target distribution π* may be considered a residual energy-based model (EBM),

$${π}^{*} ( y \vert x ) = \frac{1}{Z ( x )} {π}_{sft} ( y \vert x ) exp ( \frac{1}{β} {r}_{ϕ} ( x , y ) ) \qquad ( 6 )$$

where Z(x) is a normalizing factor known as partition function, π_{sft}. is the SFT-learned distribution (e.g., SFT 110), and

$$\frac{1}{β} {r}_{ϕ} ( x , y )$$

is the negative energy or the residual (e.g., RM 112) in the residual EBM framework (r_{ϕ} is a learned surrogate reward function, for example as trained according to Equation 3).

Since all the components in π*(y|x) are known, it can be directly samples from. For example, self-normalized importance sampling may be performed using self-normalizing importance sampling. The sampling may include two steps. First, the system may sample from the auto-regressive language model π_{sft} (y|x). Second, the system may resample according to the negative energy term,

$$\frac{1}{β} {r}_{ϕ} ( x , y ) .$$

Re-sampling with residual energy may be represented as

$$y ∼ p ( y \vert x ) = exp ( \frac{{r}_{ϕ} ( x , y )}{β} ) / {\sum }_{i = 1}^{n} exp ( \frac{{r}_{ϕ} ( x , {s}_{i} )}{β} ) .$$

Given this particular choice of sampling method (self-normalizing importance sampling) and the fact the negative energy is defined by a surrogate reward function, sampling from π*(y|x) resembles a best-of-n inference where it draws n responses from the SFT model 110 and returns the response with the highest surrogate reward as generated by RM 112. The difference is that sampling from π* is a probabilistic approach while best-of-n is greedy.

With samples from π*(y|x), parameters θ may be learned by minimizing the forward KL, [symbol] _{KL} (π*∥πθ), which amounts to maximum likelihood estimation (MLE) of θ. That is,

$${max}_{θ} {𝔼}_{x , y ∼ {𝒟}_{{π}^{*}}} log {π}_{θ} ( y \vert x ) \qquad ( 7 )$$

where [symbol] _{π*}={x, y | x ˜ [symbol] ₚᵣₒₘₚₜ, y ˜ π* (y| x)} and [symbol] ₚᵣₒₘₚₜ is a collection of prompts. This is a variant of expert iteration considering that responses from π* can be considered as “expert” responses.

Considering the advantage of DPO over MLE (or the advantage of offline RL methods over behavior cloning in general), the flexibility of framework 100 allows simple modifications on expert iteration to leverage DPO, which results in alignment with residual energy-based model (ARM). Expert iteration may follow two steps: first, sampling, and second, MLE learning. In ARM, a scoring step may be included as the second step where preference scores are collected using the learned surrogate reward function, r_{ϕ} (x, y) (e.g., RM 112). Further, DPO may be used instead of MLE to train πθ. For example, πθ may be trained using the sampled data as training data and computing a loss function that allows for direct optimization without real-time human feedback.

Given an instruction x, multiple responses may be sampled, for example y₀ and y₁, from π* (y|x). In some embodiments, a Bradley-Terry model (Equation 2) is then used to assign preference scores with the surrogate reward model, r_{ϕ}(x,y). In particular, for y₀ being preferred over y₁, y₁ [symbol] y₀, the preference probability, ρ, is

$$ρ = p ( {y}_{1} ≻ {y}_{0} \vert x ) = \frac{exp ( {r}_{ϕ} ( x ,}{exp ( {r}_{ϕ} ( x , {y}_{1} ) ) + exp ( {r}_{ϕ} ( x , {y}_{0} ) )} \qquad ( 8 )$$

and for y₀ [symbol] y₁, the preference probability may be 1−ρ. As such, a preference dataset is built by sampling from π*(y|x) and the Bradley-Terry preference model, denoted as [symbol] _{preference}={(x, y₁, y₂, ρ)}. With the preference dataset, Tte can be learned by minimizing the following objective:

$${ℒ}_{ARM} ( θ ) = - {𝔼}_{( x , {y}_{0} , {y}_{1} , ρ ) ∼ {𝒟}_{preference}} [ ρ log σ ( β log \frac{{π}_{θ} ( {y}_{1} \vert x )}{{π}_{sft} ( {y}_{1} \vert x )} - β log \frac{{π}_{θ} ( {y}_{0} \vert x )}{{π}_{sft} ( {y}_{0} \vert x )} ) + ( 1 - ρ ) log σ ( β log \frac{{π}_{θ} ( {y}_{0} \vert x )}{{π}_{sft} ( {y}_{0} \vert x )} - β log \frac{{π}_{θ} ( {y}_{1} \vert x )}{{π}_{sft} ( {y}_{1} \vert x )} ) ] \qquad ( 9 )$$

Equation (9) is a modified version of a DPO objective. An important difference over other DPO objectives is that the probability utilized is a soft label rather than either a 0 or 1. By learning the surrogate reward model (instead of the latent reward model of human) this makes the soft label possible. In some embodiments, hard labels (1 or 0) may be sampled. Generally using probability values directly lead to higher performance.

The Bradley-Terry model is one choice of reward model. The Plackett-Luce model is a generalization of the Bradley-Terry model when the number responses is more than two. One practical reason why Bradley-Terry is chosen instead of Plackett-Luce is because it is more expensive to collect preference data over multiple responses. In framework 100, preference data used to train πθ(y|x) is collected from a learned reward function (Note that the preference data used to train the surrogate reward function may still collected from human feedback). Thus, it is feasible to collect preference over multiple responses given a prompt.

As the Bradley-Terry model, the Plackett-Luce model also assumes that human preference is proportional to the value of each choice under some latent reward function, when presented a set of choices. In the LLM context, given a prompt x and a set of K LLM responses {y₁, . . . , y_{K}}, a human would give a permutation τ: [K]→[K], based on their ranking of the responses. The Plackett-Luce model states the distribution of the permutations (rankings) is,

$$( τ \vert {y}_{1} , … , {y}_{K} , x ) = {\prod }_{k = 1}^{K} \frac{exp ( r ( x , {y}_{τ ( k )} ) )}{{\sum }_{j = k}^{K} exp ( r ( x , {y}_{τ ( j )} ) )} \qquad ( 10 )$$

Notice that when K=2, Equation 10 reduces to the Bradley-Terry model (Equation 2). DPO can be generalized to the Plackett-Luce model too by parameterizing the reward function r(x, y) as log-ratios of policies. In particular,

$${p}_{θ} ( τ \vert {y}_{1} , … , {y}_{K} , x ) = {\prod }_{k = 1}^{K} \frac{exp β log \frac{{π}_{θ} ( {y}_{τ ( k )} \vert x )}{{π}_{sft} ( {y}_{1} \vert x )}}{{\sum }_{j = k}^{K} exp β log \frac{{π}_{θ} ( {y}_{τ ( j )} \vert x )}{{π}_{sft} ( {y}_{τ ( j )} \vert x )}} \qquad ( 11 )$$

Similar to ARM based on the Bradley-Terry model, an aligned policy πθ(y|x) may be learned with the following steps. First, sample K model responses,

$$\{ {y}_{1}^{( i )} , … , {y}_{K}^{( i )} \} ,$$

from π_{sft}(y|x), given a prompt x⁽ⁱ⁾. Second, score the K responses with r_{ϕ}(x,y), yielding {r_{ϕ}(x,

$${y}_{1}^{( i )} ) ,$$

. . . ,

$${r}_{ϕ} ( x , {y}_{K}^{( i )} ) \} .$$

Third, update θ by minimizing a generalized DPO loss:

$$ℂ𝔼 {(}_{PEBM} ( τ \vert {y}_{1} , … , {y}_{K} , x ) , {p}_{θ} ( τ \vert {y}_{1} , … , {y}_{K} , x ) ) \qquad ( 12 )$$

where [symbol] (p, q) is the cross-entropy from p to q, and ρ_{EBM} (τ|y₁, . . . , y_{K}, x) is the ranking distribution computed following Equation (10) with surrogate reward values from the second step) ({r_{ϕ}(x,

$${y}_{1}^{( i )} ) ,$$

. . . ,

$${r}_{ϕ} ( x , {y}_{K}^{( i )} ) \} ) .$$

In some embodiments, methods described herein may be extended to work with non-pairwise preference data. This may be beneficial, for example, in a setting where humans provide feedback to an LLM response such as to a chat-bot, where the same instruction or prompt almost never appears twice. A non-pairwise dataset [symbol] _{non-pairwise}={(x^{(i),} y⁽ⁱ⁾,

$${{z}^{( i )} ) \}}_{i = 1}^{N}$$

where zϵ{0, 1} or zϵ{like, dislike}. Methods like DPO are not applicable in the setting without pairwise preference data. Framework 100, however, is flexible and can be applied. To do so, a simple modification is made by training a surrogate reward function from the non-pairwise data [symbol] _{non-pairwise}. In particular, the reward function can be trained with the following loss function:

$$ℒ ( ϕ ) = - {E}_{( x , y , z )} ∼ {𝒟}_{non - pairwise} [ z log σ ( {r}_{ϕ} ( x , y ) ) + ( 1 - z ) ( 1 - log σ ( {r}_{ϕ} ( x , y ) ) ) ] \qquad ( 13 )$$

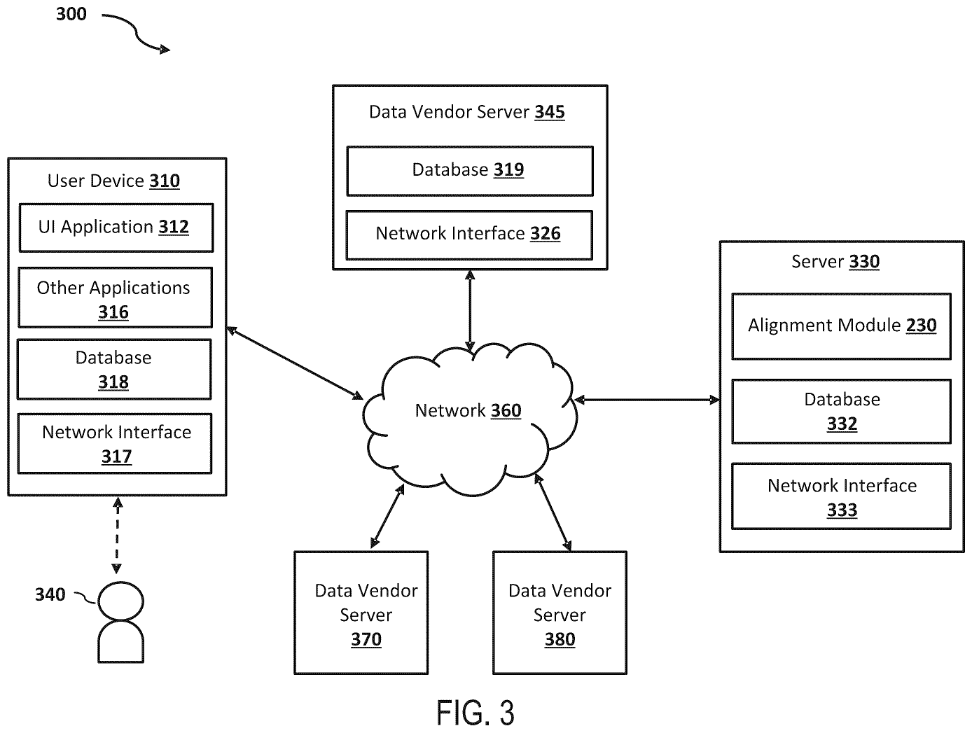

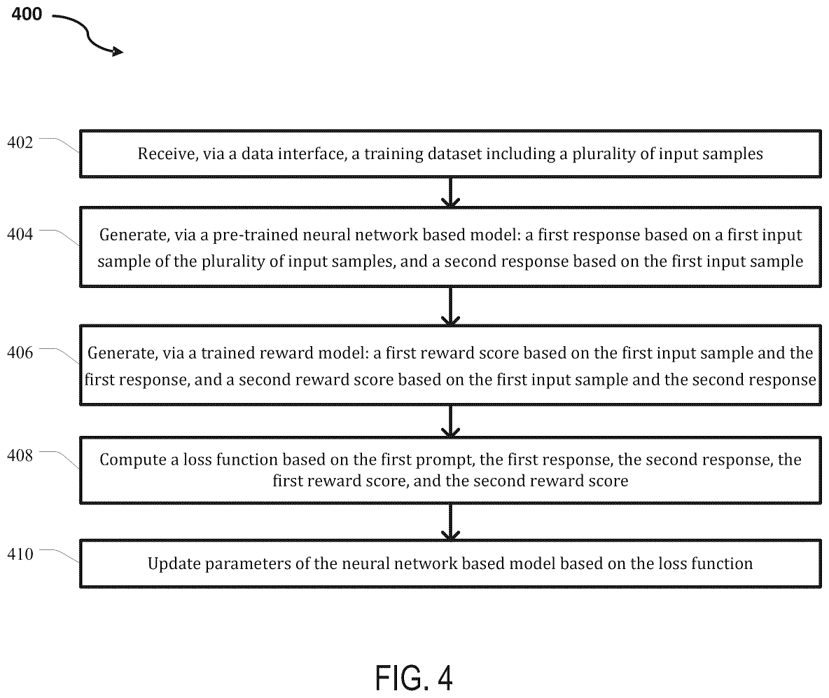

Using this modified loss, a policy can be learned via the same ARM procedure as described above and in FIGS. 4-5B.

In at least one embodiment, the framework described in FIG. 1 may be applied to a dynamic decision making system which iteratively generates a next-step action based on a current state of the environment at which the next-step action is to be carried out. A reward is provided to evaluate the next-step action. An LLM (e.g., aligned policy 118) may be implemented at a server as a chat agent application. The LLM agent may iteratively and/or dynamically determine a response based on an execution result (state) of the environment, such as a customer service environment, a simulated computer game environment, and/or the like.

In some embodiments, to complete a target task, the target task may be performed by the actor language model (e.g., aligned policy 118) in a series of actions in multiple timesteps. For example, the actor LM may receive a first prompt to generate and cause the execution of a first action at a first timestep, and then iteratively receive a respective prompt at each following timestep to generate a respective action to be performed at the following timestep. The prompt may be updated at the end of each timestep after executing an action at the respective timestep. In this way, the updated prompt may reflect the current status of task completion.

For example, an agent presented with the task of “purchase a guitar on the Amazon website” may perform a series of steps interacting with the Amazon website (or other interface such as an API) with the goal of purchasing a guitar. the AI agent may first identify available options on Amazon, using a prompt such as “sending a search query of electric query on Amazon.com”; then receive and sort through the received options, using another prompt such as “ranking the search results based on search price,” and on.

### Computer and Network Environment

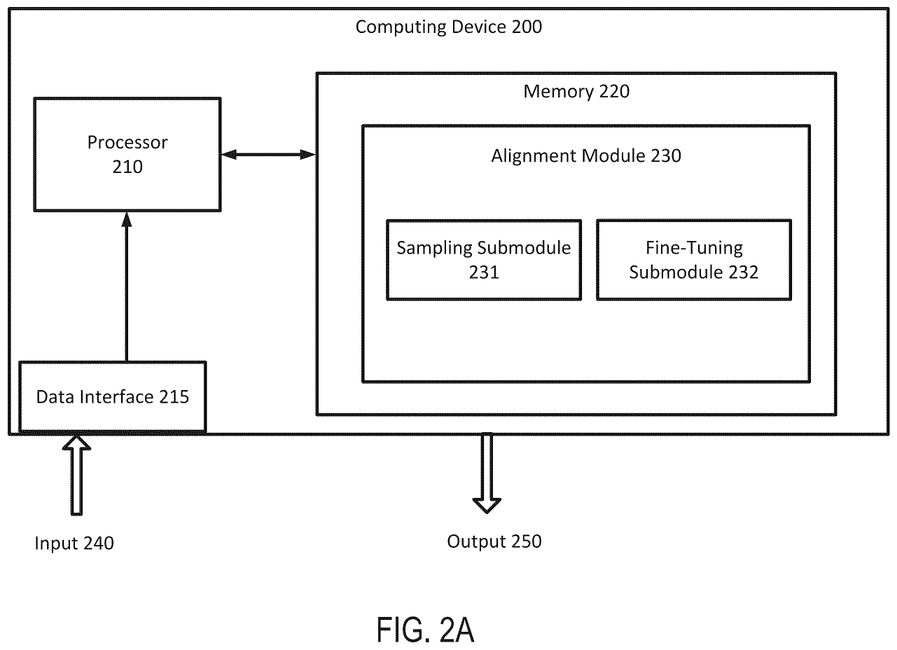

FIG. 2A is a simplified diagram illustrating a computing device implementing the model training described in FIG. 1, according to one embodiment described herein. As shown in FIG. 2A, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for alignment module 230 that may be used to implement and/or emulate the systems and models, and/or to implement any of the methods described further herein. alignment module 230 may receive input 240 such as an input training data (e.g., input prompts) via the data interface 215 and generate an output 250 which may be generated text.

The data interface 215 may comprise a communication interface, a user interface (such as a voice input interface, a graphical user interface, and/or the like). For example, the computing device 200 may receive the input 240 (such as a training dataset) from a networked database via a communication interface. Or the computing device 200 may receive the input 240, such as input prompts, from a user via the user interface.

In some embodiments, the alignment module 230 is configured to align a neural network based model via the training framework described in FIG. 1. The alignment module 230 may further include sampling submodule 231 configured to sample output responses from a neural network based model as described herein. The alignment module 230 may further include fine-tuning submodule 232 configured to update parameters of a neural network based model according to a loss function based on outputs and rewards as described herein.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 2B is a simplified diagram illustrating the neural network structure implementing the alignment module 230 described in FIG. 2A, according to some embodiments. In some embodiments, the alignment module 230 and/or one or more of its submodules 231-232 may be implemented at least partially via an artificial neural network structure shown in FIG. 2B. The neural network comprises a computing system that is built on a collection of connected units or nodes, referred to as neurons (e.g., 244, 245, 246). Neurons are often connected by edges, and an adjustable weight (e.g., 251, 252) is often associated with the edge. The neurons are often aggregated into layers such that different layers may perform different transformations on the respective input and output transformed input data onto the next layer.

For example, the neural network architecture may comprise an input layer 241, one or more hidden layers 242 and an output layer 243. Each layer may comprise a plurality of neurons, and neurons between layers are interconnected according to a specific topology of the neural network topology. The input layer 241 receives the input data (e.g., 240 in FIG. 2A), such as an input prompt. The number of nodes (neurons) in the input layer 241 may be determined by the dimensionality of the input data (e.g., the length of a vector of an input prompt. Each node in the input layer represents a feature or attribute of the input.

The hidden layers 242 are intermediate layers between the input and output layers of a neural network. It is noted that two hidden layers 242 are shown in FIG. 2B for illustrative purpose only, and any number of hidden layers may be utilized in a neural network structure. Hidden layers 242 may extract and transform the input data through a series of weighted computations and activation functions.

For example, as discussed in FIG. 2A, the alignment module 230 receives an input 240 of an input prompt and transforms the input into an output 250 of generated text. To perform the transformation, each neuron receives input signals, performs a weighted sum of the inputs according to weights assigned to each connection (e.g., 251, 252), and then applies an activation function (e.g., 261, 262, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 241 is transformed into rather different values indicative data characteristics corresponding to a task that the neural network structure has been designed to perform.

The output layer 243 is the final layer of the neural network structure. It produces the network's output or prediction based on the computations performed in the preceding layers (e.g., 241, 242). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the alignment module 230 and/or one or more of its submodules 231-232 may comprise the transformative neural network structure of layers of neurons, and weights and activation functions describing the non-linear transformation at each neuron. Such a neural network structure is often implemented on one or more hardware processors 210, such as a graphics processing unit (GPU). An example neural network may be an LLM, and/or the like.

In one embodiment, the alignment module 230 and its submodules 231-232 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

In one embodiment, the alignment module 230 and its submodules 231-232 may be implemented by hardware, software and/or a combination thereof. For example, the alignment module 230 and its submodules 231-232 may comprise a specific neural network structure implemented and run on various hardware platforms 260, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 260 used to implement the neural network structure is specifically configured based on factors such as the complexity of the neural network, the scale of the tasks (e.g., training time, input data scale, size of training dataset, etc.), and the desired performance.

In one embodiment, the neural network based alignment module 230 and one or more of its submodules 231-232 may be trained by iteratively updating the underlying parameters (e.g., weights 251, 252, etc., bias parameters and/or coefficients in the activation functions 261, 262 associated with neurons) of the neural network based on the loss described in Eq. (9). For example, during forward propagation, the training data such as input prompts are fed into the neural network. The data flows through the network's layers 241, 242, with each layer performing computations based on its weights, biases, and activation functions until the output layer 243 produces the network's output 250. In some embodiments, output layer 243 produces an intermediate output on which the network's output 250 is based.

The output generated by the output layer 243 is compared to the expected output (e.g., a “ground-truth” such as the corresponding known good output) from the training data, to compute a loss function that measures the discrepancy between the predicted output and the expected output. For example, the loss function may be cross entropy, MMSE, or according to Eq. (9). Given the loss, the negative gradient of the loss function is computed with respect to each weight of each layer individually. Such negative gradient is computed one layer at a time, iteratively backward from the last layer 243 to the input layer 241 of the neural network. These gradients quantify the sensitivity of the network's output to changes in the parameters. The chain rule of calculus is applied to efficiently calculate these gradients by propagating the gradients backward from the output layer 243 to the input layer 241.

In one embodiment, the neural network based alignment module 230 and one or more of its submodules 231-232 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like, such as in Eq. (9). These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

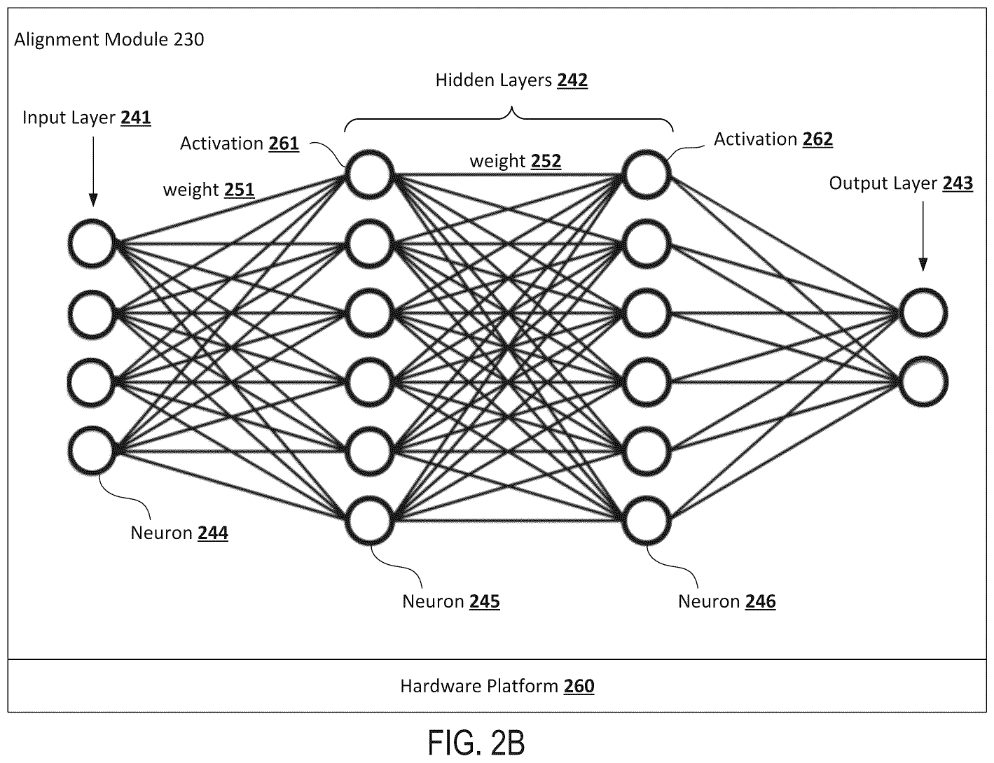

In one embodiment, alignment module 230 and its submodules 231-232 may be housed at a centralized server (e.g., computing device 200) or one or more distributed servers. For example, one or more of alignment module 230 and its submodules 231-232 may be housed at external server(s). The different modules may be communicatively coupled by building one or more connections through application programming interfaces (APIs) for each respective module. Additional network environment for the distributed servers hosting different modules and/or submodules may be discussed in FIG. 3.

During a backward pass, parameters of the neural network are updated backwardly from the last layer to the input layer (backpropagating) based on the computed negative gradient using an optimization algorithm to minimize the loss. The backpropagation from the last layer 243 to the input layer 241 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen input prompts.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in training of neural network based models, and more specifically to efficient alignment of LLMs.

FIG. 3 is a simplified block diagram of a networked system 300 suitable for implementing the model training framework described in FIGS. 1-2 and other embodiments described herein. In one embodiment, system 300 includes the user device 310 which may be operated by user 340, data vendor servers 345, 370 and 380, server 330, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2A, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 310, data vendor servers 345, 370 and 380, and the server 330 may communicate with each other over a network 360. User device 310 may be utilized by a user 340 (e.g., a driver, a system admin, etc.) to access the various features available for user device 310, which may include processes and/or applications associated with the server 330 to receive an output data anomaly report.

User device 310, data vendor server 345, and the server 330 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

User device 310 may be implemented as a communication device that may utilize appropriate hardware and software configured for wired and/or wireless communication with data vendor server 345 and/or the server 330. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312, and/or other applications 316, which may correspond to executable processes, procedures, and/or applications with associated hardware. For example, the user device 310 may receive a message indicating a generated output from the server 330 and display the message via the UI application 312. In other embodiments, user device 310 may include additional or different modules having specialized hardware and/or software as required.

In one embodiment, UI application 312 may communicatively and interactively generate a UI for an AI agent implemented through the alignment module 230 (e.g., an LLM agent) at server 330. In at least one embodiment, a user operating user device 310 may enter a user utterance, e.g., via text or audio input, such as a question, uploading a document, and/or the like via the UI application 312. Such user utterance may be sent to server 330, at which alignment module 230 may generate a response via the process described in FIG. 1. The alignment module 230 may thus cause a display of generated text or other output at UI application 312 and interactively update the display in real time with the user utterance.

In various embodiments, user device 310 includes other applications 316 as may be desired in particular embodiments to provide features to user device 310. For example, other applications 316 may include security applications for implementing client-side security features, programmatic client applications for interfacing with appropriate application programming interfaces (APIs) over network 360, or other types of applications. Other applications 316 may also include communication applications, such as email, texting, voice, social networking, and IM applications that allow a user to send and receive emails, calls, texts, and other notifications through network 360. For example, the other application 316 may be an email or instant messaging application that receives a prediction result message from the server 330. Other applications 316 may include device interfaces and other display modules that may receive input and/or output information. For example, other applications 316 may contain software programs for asset management, executable by a processor, including a graphical user interface (GUI) configured to provide an interface to the user 340 to view generated outputs.

User device 310 may further include database 318 stored in a transitory and/or non-transitory memory of user device 310, which may store various applications and data and be utilized during execution of various modules of user device 310. Database 318 may store user profile relating to the user 340, predictions previously viewed or saved by the user 340, historical data received from the server 330, and/or the like. In some embodiments, database 318 may be local to user device 310. However, in other embodiments, database 318 may be external to user device 310 and accessible by user device 310, including cloud storage systems and/or databases that are accessible over network 360.

User device 310 includes at least one network interface component 317 adapted to communicate with data vendor server 345 and/or the server 330. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 345 may correspond to a server that hosts database 319 to provide training datasets including input prompts to the server 330. The database 319 may be implemented by one or more relational database, distributed databases, cloud databases, and/or the like.

The data vendor server 345 includes at least one network interface component 326 adapted to communicate with user device 310 and/or the server 330. In various embodiments, network interface component 326 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 345 may send asset information from the database 319, via the network interface 326, to the server 330.

The server 330 may be housed with the alignment module 230 and its submodules described in FIG. 2A. In some implementations, alignment module 230 may receive data from database 319 at the data vendor server 345 via the network 360 to generate outputs. The generated outputs may also be sent to the user device 310 for review by the user 340 via the network 360.

The database 332 may be stored in a transitory and/or non-transitory memory of the server 330. In one implementation, the database 332 may store data obtained from the data vendor server 345. In one implementation, the database 332 may store parameters of the alignment module 230. In one implementation, the database 332 may store previously generated outputs, and the corresponding input feature vectors.

In some embodiments, database 332 may be local to the server 330. However, in other embodiments, database 332 may be external to the server 330 and accessible by the server 330, including cloud storage systems and/or databases that are accessible over network 360.

The server 330 includes at least one network interface component 333 adapted to communicate with user device 310 and/or data vendor servers 345, 370 or 380 over network 360. In various embodiments, network interface component 333 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 360 may be implemented as a single network or a combination of multiple networks. For example, in various embodiments, network 360 may include the Internet or one or more intranets, landline networks, wireless networks, and/or other appropriate types of networks. Thus, network 360 may correspond to small scale communication networks, such as a private or local area network, or a larger scale network, such as a wide area network or the Internet, accessible by the various components of system 300.

### Example Work Flows

FIG. 4 is an example logic flow diagram illustrating a method of fine-tuning a neural network based model based on the framework shown in FIGS. 1-3, according to some embodiments described herein. One or more of the processes of method 400 may be implemented, at least in part, in the form of executable code stored on non-transitory, tangible, machine-readable media that when run by one or more processors may cause the one or more processors to perform one or more of the processes. In some embodiments, method 400 corresponds to the operation of the alignment module 230 (e.g., FIGS. 2A and 3) that performs alignment of neural network based models.

As illustrated, the method 400 includes a number of enumerated steps, but aspects of the method 400 may include additional steps before, after, and in between the enumerated steps. In some aspects, one or more of the enumerated steps may be omitted or performed in a different order.

At step 402, a system (e.g., computing device 200, user device 310, or server 330) receives, via a data interface (e.g., data interface 215, UI application 312, network interface 317, or network interface 333), a training dataset including a plurality of input samples.

At step 404, the system generates, via a pre-trained neural network based model:

a first response based on a first input sample of the plurality of input samples, and a second response based on the first input sample. In some embodiments, additional (i.e., n) responses may be generated and then there may be a resampling step in which fewer (i.e., 2) are sampled from the original n, for example via self-normalizing importance sampling.

At step 406, the system generates, via a trained reward model: a first reward score based on the first input sample and the first response, and a second reward score based on the first input sample and the second response. In some embodiments, the first reward score and/or the second reward score are values between 0 and 1. In some embodiments, the first and second reward scores sum to 1. The trained reward model may directly output unscaled reward scores that do not sum to 1, but the respective reward scores may be normalized to sum to 1. In some embodiments, the system may generate additional responses and respective reward scores (e.g., a third response and third reward score), and in that case the reward scores may be normalized so the sum of all the reward scores is 1.

At step 408, the system computes a loss function based on the first prompt, the first response, the second response, the first reward score, and the second reward score. In some embodiments, computing the loss function includes summing values based on: a first comparison of a probability of the neural network based model generating the first response and a probability of the neural network based model generating the second response, scaled by the first reward score, and a second comparison of the probability of the neural network based model generating the first response and the probability of the neural network based model generating the second response, scaled by the second reward score. For example, the loss function may be the loss function described in equation (9). If additional responses and respective reward scores are generated, the loss function may further be based on those additional responses and reward scores.

At step 410, the system updates parameters of a neural network based model based on the loss function. In some embodiments, the neural network based model is initialized with a same set of parameters as the pre-trained neural network based model. In some embodiments, the neural network based model is the pre-trained neural network based model. In some embodiments, they are distinct models.

FIG. 5A provides an example pseudo-code segment illustrating an example algorithm 500 for a method of fine-tuning a neural network based model based on the framework shown in FIGS. 1-4. FIG. 5B provides an example logic flow diagram illustrating a method of a fine-tuning a neural network based model according to the algorithm 500 in FIG. 5A, according to some embodiments described herein. One or more of the processes of method 550 may be implemented, at least in part, in the form of executable code stored on non-transitory, tangible, machine-readable media that when run by one or more processors may cause the one or more processors to perform one or more of the processes. In some embodiments, method 550 corresponds to an example operation of the alignment module 230 (e.g., FIG. 2A). Aspects of method 550 may be the same, similar, and/or work together with aspects of method 400.

As illustrated, the method 550 includes a number of enumerated steps, but aspects of the method 550 may include additional steps before, after, and in between the enumerated steps. In some aspects, one or more of the enumerated steps may be omitted or performed in a different order. The methods 500 and 550 may be referred to as “ARM”.

At step 502, a system (e.g., computing device 200, user device 310, or server 330) receives or otherwise provides a pretrained model (represented as π* (y|x)) and a training dataset [symbol] ₚᵣₒₘₚₜ={x}.

At step 504, the system samples multiple completions (e.g., y0 and y1) by the pretrained model given inputs from the training dataset. Sampling may be self-normalizing importance sampling that may include two stages of sampling, a first proposal sampling of n samples, and a resampling with residual energy based on a reward model.

At step 506, the system scores the completions and computes the preference probability via the reward model, thereby providing [symbol] _{preference}={(x, y₁, y₂, ρ)} where ρ represents the relative preference of y₁ with respect to y₂.

At step 508, the system updates parameters ϕ of the pretrained model, for example via direct preference optimization (DPO).

### Example Results

FIGS. 6-11 provide charts illustrating exemplary performance of different embodiments described herein. Embodiments of methods described herein (denoted in the experiment descriptions as “ARM”) were validated in a variety of settings. For example, with only access to non-pairwise human feedback, and with only access to a limited amount of pairwise human feedback. These experiments demonstrate the flexibility of methods described herein and applicability to realistic scenarios. In the experiments, the focus is on ARM based on the Bradley-Terry model as described in FIG. 1. ARM based on Bradley-Terry model is also compared to Plackett-Luce. An ablation study was also performed on the number of proposal samples used in the self-normalizing importance sampling, n.

Experiments were conducted on three datasets. Each dataset contains two subsets: 1) an SFT dataset [symbol] _{sft}={(x⁽ⁱ⁾,

$${{y}^{( i )} ) \}}_{i = 1}^{N} ;$$

2) and a human preference dataset [symbol] _{pref} ={(x⁽ⁱ⁾, y_{w}⁽ⁱ⁾,

$${{y}_{l}^{( i )} ) \}}_{i = 1}^{N} .$$

An SFT model was first learned with [symbol] _{sft} and a reward model with [symbol] _{pref}, and then a policy model trained with the method described herein (i.e., “ARM”).

One set of datasets and evaluation methods are from “AlpacaFarm” as described in Dubois et al., AlpacaFarm: A simulation framework for methods that learn from human feedback, arXiv:2305.14387, 2023. AlpacaFarm provides a suite of datasets and evaluation methods that enables research and development for learning from feedback. Experiments used the SFT split (10k) and pairwise preference split (10k) as [symbol] _{sf}t and [symbol] _{pref} respectively. Alpaca data cover diverse topics and models trained on it has shown non-trivial instruction following capacities.

The second dataset is the Reddit TL;DR summarization dataset as described in Völske et al., TL;DR: Mining reddit to learn automatic summarization, Proceedings of the Workshop on New Frontiers in Summarization, pp. 59-63, 2017. In TL;DR, x is a post from reddit.com with a variety of topics (subreddits), and y is summary written by the original poster (TL;DR). The dataset version used in experiments has 123k posts as [symbol] _{sft}. A 64k summary comparison on the TL;DR dataset was used as [symbol] _{pref}.

The third dataset is Anthropic's Helpful and Harmless (HH) dataset where each instance consists of a conversation between a human and an AI assistant. In HH, x is a human query (potentially with some conversation history), and y is a response generated by a large (unknown) language model. HH has 170k examples. It does not have a separate [symbol] _{sft} set, while each instance has a query and two responses (chosen and rejected). Experiments used the collection of query and chosen response as [symbol] _{sft}.

In AlpacaFarm experiments, the baseline for comparison includes a pre-trained SFT and reward models as described in Dubois et al., AlpacaFarm: A simulation framework for methods that learn from human feedback, arXiv:2305.14387, 2023.

To evaluate methods described herein, experiments compute the win-rate of model responses against preferred responses by human. The comparison was done by GPT-4 (gpt-4-0314).

FIG. 6 illustrates improvements of ARM over a SFT model under various settings. The y-axis is the win-rate of LLM responses compared to human responses in the Anthropic Helpful-Harmful dataset.

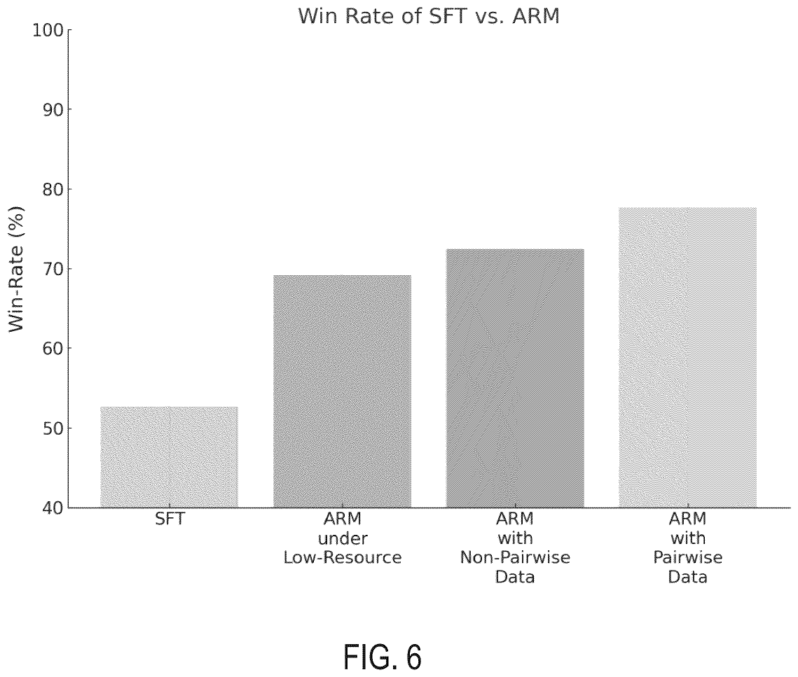

FIG. 7 illustrates primary results across the three datasets. In comparison to SFT, all methods show sizeable advancements. Simple training method, Expert Iteration, achieves a 14% to 30% improvement over SFT. The standard RLHF method, PPO, and DPO, show even greater enhancements beyond Expert Iteration. Notably, the inference-based method, best-of-n, performs surprisingly well, yielding comparable or superior win rates when compared to both PPO and DPO. Finally, ARM improves the win-rates significantly. In comparison to the previously top-performing methods, PPO, DPO, and best-of-n, ARM also exhibits substantial improvements, ranging from 7% to 15%.

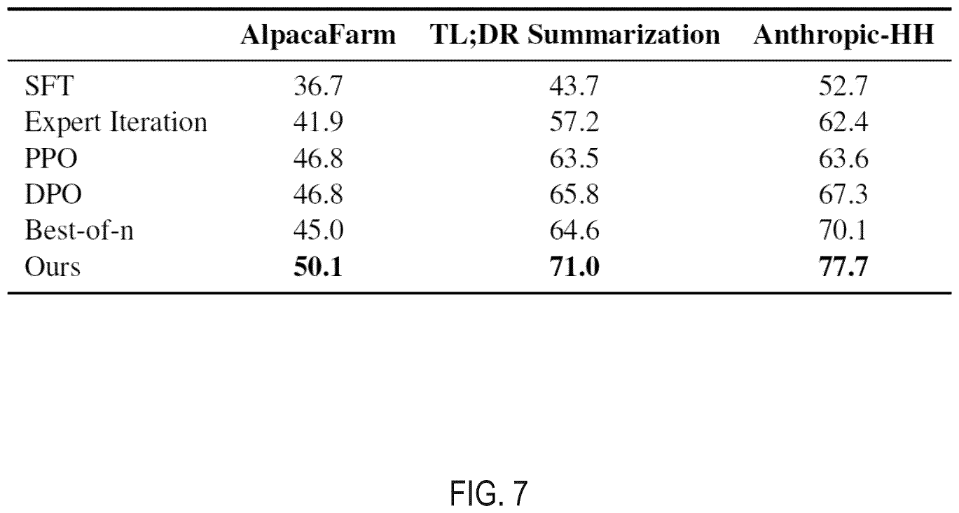

FIG. 8 illustrates win-rates on three datasets when the model is trained only with access to non-pairwise preference data. As illustrated, ARM outperforms Expert Iteration and best-of-n. Further, ARM still yields substantial enhancements over the SFT model, especially on AlpacaFarm and Anthropic-HH.

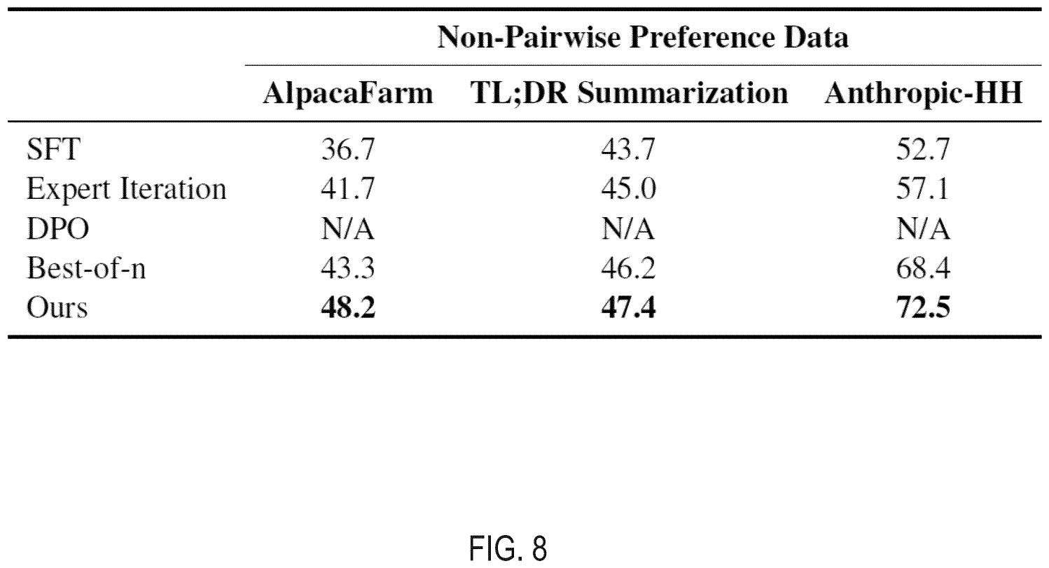

FIG. 9 illustrates win-rates on the TL; DR summarization and Anthropic-HH with only access to a limited amount of preference data (2k and 8k). As illustrated, ARM is able to produce significant improvements over SFT policy, and the improvements are larger compared to baselines. Further, although in the 2k setting, the ARM performance is weakened compared to the full dataset performance, it is able to recover a large proportion of the performance of the models trained with the full dataset, especially on Anthropic-HH.

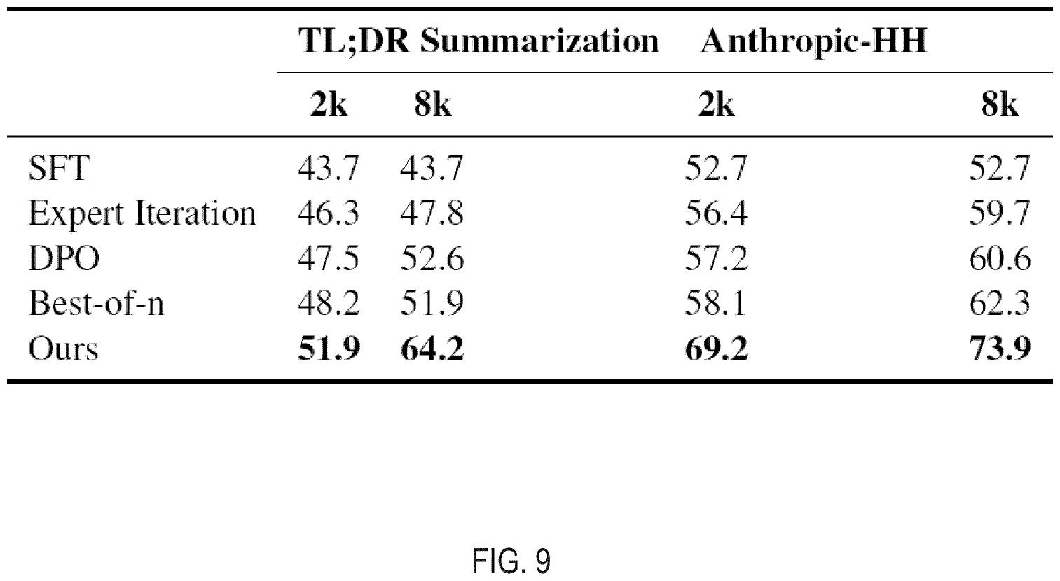

FIG. 10 illustrates win-rates on the TL;DR summarization and Anthropic-HH with Bradley-Terry versus Packett-Luce as the human preference model. As illustrated, in both datasets, ARM with Plackett-Luce slightly underperforms ARM with Bradley-Terry. One explanation for the difference in performance is that Plackett-Luce requires more preference accurate labels compared to Bradley-Terry, since it learns from more nuanced comparisons, while the surrogate reward function is noisy.

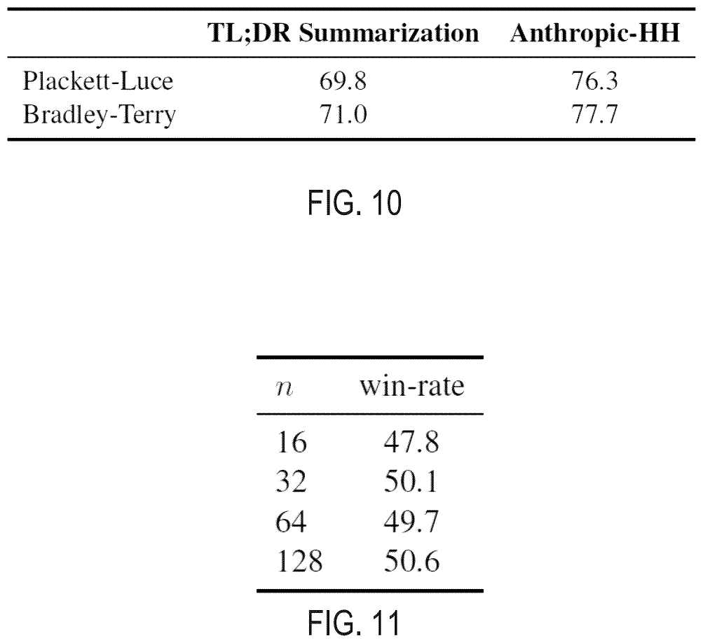

FIG. 11 illustrates an ablation study on the number of proposal samples, n, in the self-normalizing importance sampling. As illustrated, as n increases from 16 to 32, there is a clear improvement on win rate. However, further increasing n yields no improvement.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is;:

1. A method of fine-tuning a neural network based model, the method comprising:
receiving, via a data interface, a training dataset including a plurality of input samples;
generating, via a pre-trained neural network based model:
a first response based on a first input sample of the plurality of input samples, and
a second response based on the first input sample;
generating, via a trained reward model:
a first reward score based on the first input sample and the first response, and
a second reward score based on the first input sample and the second response;
computing a loss function based on the first prompt, the first response, the second response, the first reward score, and the second reward score; and
updating parameters of the neural network based model based on the loss function.

2. The method of claim 1, wherein the first reward score is a value between 0 and 1.

3. The method of claim 2, wherein the first reward score and the second reward score sum to 1.

4. The method of claim 1, wherein the computing the loss function includes summing values based on:
a first comparison of a first probability that the neural network based model generates the first response and a second probability that the neural network based model generates the second response, scaled by the first reward score; and
a second comparison of the first probability that the neural network based model generates the first response and the probability that the neural network based model generates the second response, scaled by the second reward score.

5. The method of claim 1, further comprising:
generating, via the pre-trained neural network based model, a third response based on the first input sample; and
generating, via the trained reward model, a third reward score based on the first input sample and the third response,
wherein the computing the loss function is further based on the third response and the third reward score.

6. The method of claim 1, wherein the neural network based model is initialized with a same set of parameters as the pre-trained neural network based model.

7. The method of claim 1, wherein the neural network based model is the pre-trained neural network based model.

8. A system for fine-tuning a neural network based model, the system comprising:
a memory that stores the neural network based model and a plurality of processor executable instructions;
a communication interface that receives a training dataset including a plurality of input samples; and
one or more hardware processors that read and execute the plurality of processor-executable instructions from the memory to perform operations comprising:
generating, via a pre-trained neural network based model:
a first response based on a first input sample of the plurality of input samples, and
a second response based on the first input sample;
generating, via a trained reward model: a first reward score based on the first input sample and the first response, and a second reward score based on the first input sample and the second response;
computing a loss function based on the first prompt, the first response, the second response, the first reward score, and the second reward score; and
updating parameters of the neural network based model based on the loss function.

9. The system of claim 8, wherein the first reward score is a value between 0 and 1.

10. The system of claim 9, wherein the first reward score and the second reward score sum to 1.

11. The system of claim 8, wherein the computing the loss function includes summing values based on:
a first comparison of a first probability that the neural network based model generates the first response and a second probability that the neural network based model generates the second response, scaled by the first reward score; and
a second comparison of the first probability that the neural network based model generates the first response and the probability that the neural network based model generates the second response, scaled by the second reward score.

12. The system of claim 8, wherein the one or more hardware processors perform operations further comprising:
generating, via the pre-trained neural network based model, a third response based on the first input sample; and
generating, via the trained reward model, a third reward score based on the first input sample and the third response,
wherein the computing the loss function is further based on the third response and the third reward score.

13. The system of claim 8, wherein the neural network based model is initialized with a same set of parameters as the pre-trained neural network based model.

14. The system of claim 8, wherein the neural network based model is the pre-trained neural network based model.

15. A non-transitory machine-readable medium comprising a plurality of machine-executable instructions which, when executed by one or more processors, are adapted to cause the one or more processors to perform operations comprising:
receiving, via a data interface, a training dataset including a plurality of input samples;
generating, via a pre-trained neural network based model:
a first response based on a first input sample of the plurality of input samples, and
a second response based on the first input sample;
generating, via a trained reward model:
a first reward score based on the first input sample and the first response, and
a second reward score based on the first input sample and the second response;
computing a loss function based on the first prompt, the first response, the second response, the first reward score, and the second reward score; and
updating parameters of a neural network based model based on the loss function.

16. The non-transitory machine-readable medium of claim 15, wherein the first reward score is a value between 0 and 1.

17. The non-transitory machine-readable medium of claim 16, wherein the first reward score and the second reward score sum to 1.

18. The non-transitory machine-readable medium of claim 15, wherein the computing the loss function includes summing values based on:
a first comparison of a first probability that the neural network based model generates the first response and a second probability that the neural network based model generates the second response, scaled by the first reward score; and
a second comparison of the first probability that the neural network based model generates the first response and the probability that the neural network based model generates the second response, scaled by the second reward score.

19. The non-transitory machine-readable medium of claim 15, wherein the machine-executable instructions, when executed by one or more processors, are adapted to cause the one or more processors to further perform operations comprising:
generating, via the pre-trained neural network based model, a third response based on the first input sample; and
generating, via the trained reward model, a third reward score based on the first input sample and the third response,
wherein the computing the loss function is further based on the third response and the third reward score.

20. The non-transitory machine-readable medium of claim 15, wherein the neural network based model is initialized with a same set of parameters as the pre-trained neural network based model.
